(19) United States
(12) Patent Application Publication
(10) Pub. No.: US 2012/0163398 A1
(43) Pub. Date: Jun. 28, 2012

(54) COMMUNICATION APPARATUS, RELAY APPARATUS, AND NETWORK SYSTEM

(75) Inventor: Toshihiko KURITA, Kawasaki (JP)

(73) Assignee: FUJITSU LIMITED, Kawasaki-shi (JP)

(21) Appl. No.: 13/332,838

(22) Filed: Dec. 21, 2011

(30) Foreign Application Priority Data
Dec. 28, 2010 (JP) 2010-291959

(51) Int. Cl. H04L 12/43

(52) U.S. Cl. 370/458

(57) ABSTRACT

A relay apparatus of performing packet communication of time division, including: a receiver configured to receive a first data packet to be transmitted pursuant to a reservation of a time slot, a second data packet, and a control packet including first data representing which of the first data packet and the second data packet is to be transmitted in the same time slot; a processor configured to, in a case where the control packet including first data representing that the second data packet is to be transmitted in the same time slot, store in a data storage the second data packet; and a transmitter configured to transmit the second data packet stored in the data storage in a time slot not including other data packet than the second data packet.

### CROSS-REFERENCE TO RELATED APPLICATION

This application is based upon and claims the benefit of priority from the prior Japanese Patent Application No. 2010-291959 filed on Dec. 28, 2010, the entire contents of which are incorporated herein by reference.

### FIELD

The embodiments discussed herein relate to a communication apparatus, relay apparatus, network system and techniques for packet communication of time division in wired networks.

### BACKGROUND

Recently, there have been movements to integrate a local area network (LAN), which accommodates server-based traffic, and a storage area network (SAN) and or a disk area network (DAN), which accommodates disk-based traffic, into one network. When such integration is carried out, one network accommodates different kinds of traffic that are different in terms of properties such as the necessity or unnecessity of band guarantee.

On the other hand, there exists a technique that systematically reduces power consumption of routers using a time division multiplexing (TDM) communication method by using time slots (hereinafter referred to also as “slots”). For example, in an example illustrated in FIG. 1, pseudo-slots are synchronously generated at certain time intervals at edge nodes using an approach like circuit switching, and scheduling of packet transmission is made appropriately in accordance with this. At relay nodes, pseudo-slots are identified and packets are switched at each slot, and thus bufferless transmission is performed, which achieves power savings. That is, a routing table using a memory capable of high-speed search and data buffering by using a large-capacity memory are avoided, resulting in reduction in power consumption of a router.

There also exists a technique in which a management server dynamically assigns a plurality of paths (hereinafter referred to also as “flows”) to slots in accordance with a band to be used for a route determined depending on a combination of edge nodes. For example, this technique is realized by a pre-operation, static assignment of a fixed number of flows and a post-operation, dynamic assignment of a varying number of flows.

In any technique, however, an assignment is made such that each flow occupies the band assigned thereto. Accordingly, for example, as illustrated in FIG. 2, if part of a band assigned to one flow is not used, another flow cannot perform communication using a band exceeding its assigned band. In the example of FIG. 2, assuming that the band of each link is 1.0 Gbps, 0.5 Gbps is assigned to each of two flows, a flow A and a flow B. Note that bands are assigned to flows in such a manner that the sum of bands in each link does not exceed 1.0 Gbps, and therefore 0.5 Gbps is assigned to each of the flow A and the flow B in accordance with the band of a bottleneck portion. In conventional techniques, even in the case where the band actually used for the flow A is less than 0.5 Gbps, the flow B cannot use a band other than the band, 0.5 Gbps, assigned to the flow B.

Japanese Unexamined Patent Application Publication Nos. 2010-141443, 2003-229857, 2002-247072, and 8-125654 are examples of the related art.

The related art is also disclosed in Mitsunobu, Kurita, and Kakemizu, “Packet Transmission Scheduling for Network Power Saving: Application for Bufferless Network” in Proceedings of the IEICE General Conference 2010, published by the Institute of Electronics, Information and Communication Engineers, March 2010; and Kurita, Mitsunobu, and Kakemizu, “Packet Transmission Scheduling for Network Power Saving”, in IEICE technical report published by the Institute of Electronics, Information and Communication Engineers, March 2010.

### SUMMARY

According to an aspect of the invention, a relay apparatus for performing packet communication of time division includes a receiver configured to receive a first data packet to be transmitted according to a reservation of a time slot, a second data packet being a data packet other than the first data packet, and a control packet including first data representing which of the first data packet and the second data packet is to be transmitted in the same time slot as the control packet; a processor configured to store in a data storage the second data packet, the second data packet being received by the receiver in a time slot in which the control packet is received, when the receiver receives a control packet including first data representing that the second data packet is to be transmitted in the same time slot as the control packet; and a transmitter configured to transmit the second data packet stored in the data storage in a time slot not including other data packet than the second data packet.

The object and advantages of the invention will be realized and attained by at least the features, elements, and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates a related art technique.

FIG. 2 illustrates another related art technique.

FIG. 3 is an illustration for explaining a configuration of a network system according to an embodiment.

FIG. 4 is an illustration for explaining processing of a network system according to the embodiment.

FIG. 5 is a block diagram illustrating functions of an end system according to the embodiment.

FIG. 6 is a block diagram illustrating functions of a relay node according to the embodiment.

FIG. 7 illustrates a processing flow in the case where the end system receives a packet.

FIG. 8 illustrates an example of data to be stored in the end system table storage.

FIG. 9 illustrates an example of data to be stored in a path management table storage.

FIG. 10 illustrates an example of data to be stored in a slot reservation table storage.

FIG. 11 illustrates a processing flow of interrupt processing in the end system.

FIG. 12 illustrates an example of the meanings of values of a marking policy (mark parameter).

FIG. 13 illustrates an example of marking policies (mark parameters).

FIG. 14A is an illustration for explaining the relationship between the control packets and the slot.

FIG. 14B is an illustration for explaining an example of the format of a control packet.

FIG. 14C is an illustration for explaining an example of the header of a control packet.

FIG. 14D is an illustration for explaining an example of the payload of a control packet.

FIG. 15 illustrates a processing flow of a process when the relay node receives packets.

FIG. 16 illustrates an example of data stored in a slot table storage.

FIG. 17 illustrates a processing flow of interrupt processing in the relay node.

FIG. 18 is a block diagram illustrating functions of a computer.

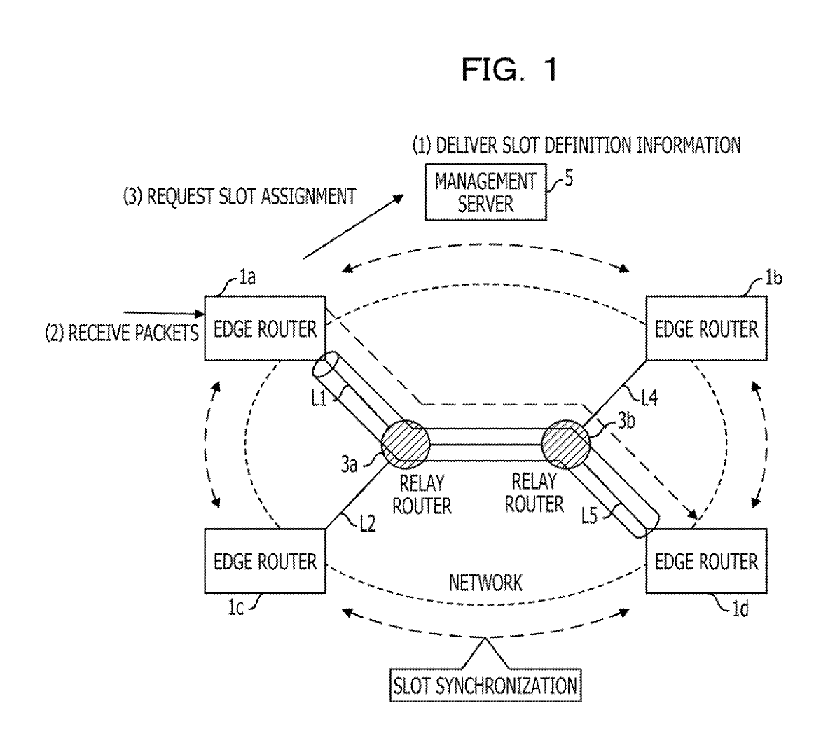

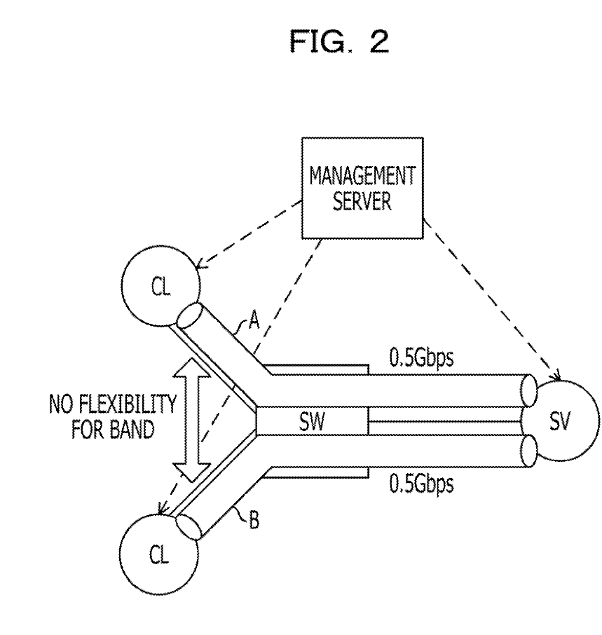

### DESCRIPTION OF EMBODIMENTS

An object of the invention, as an aspect, is to provide a technique for improving network utilization efficiency.

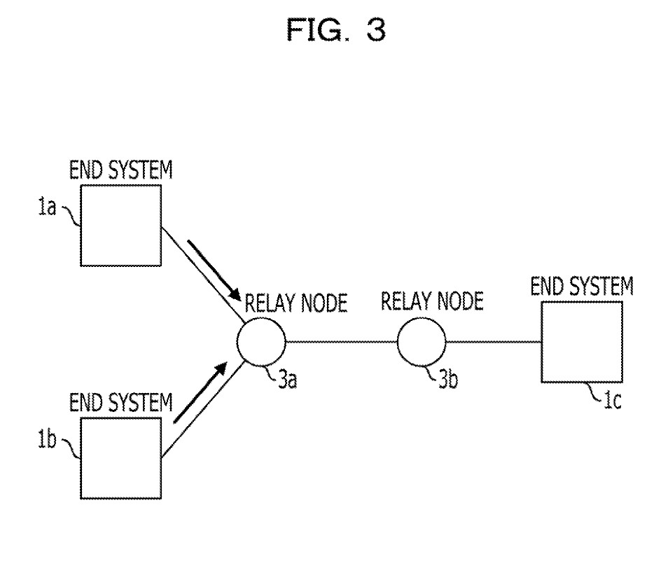

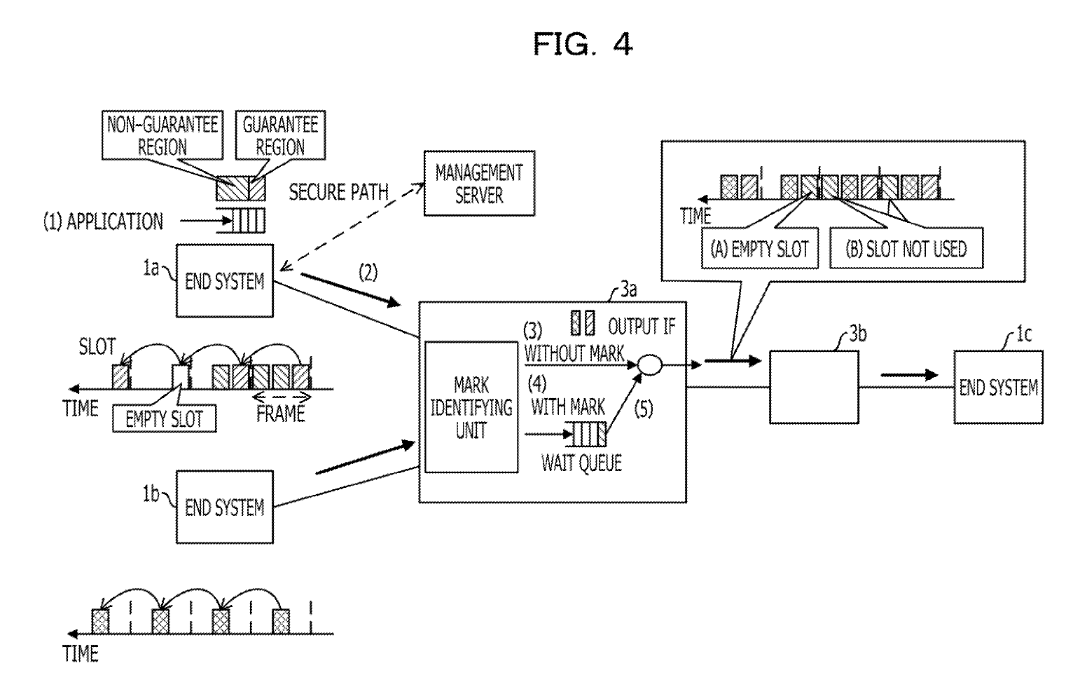

First, with reference to FIG. 3 and FIG. 4, processing of the entirety of a network system according to an embodiment of this technique.

This embodiment will be described with a network configuration as illustrated in FIG. 3 taken as an example. The network system of FIG. 3 includes three end systems 1 (e.g., end systems 1a, 1b, and 1c) and two relay nodes 3 (e.g., relay nodes 3a and 3b). The end system 1a is wired with the relay node 3a, the end system 1b is wired with the relay node 3a, the relay node 3a is wired with the relay node 3b, and the relay node 3b is wired with the end system 1c. As indicated by arrows, there exist traffic flows to the end system 1c from both the end system 1a and the end system 1b. Note that the end system 1 may be a terminal for transmitting and receiving data packets, and may be an edge node connected to such a terminal. Such a network system is used for time division multiplexing communication.

With reference to FIG. 4, operations of the end system 1 and the relay node 3 will next be described. In time division multiplexing communication, a time period in which a communication line is used is separated into given frames, and each frame is divided into a plurality of slots. The plurality of slots are used for communication. That is, each slot in turn functions as a communication timing in a certain frame period. In FIG. 4, packets transmitted from the end system 1a, the end system 1b, and the relay node 3a are schematically illustrated along the time axis. Note that each frame is divided into three slots, and each rectangle represents one slot. Here assume that the first slot in each frame is reserved for a path from the end system 1a to the end system 1c, and the second slot in each frame is reserved for a path from the end system 1b to the end system 1c.

The reservation of a slot is made as follows. That is, the end system 1 transmits a slot assignment request including the identifier of a source end system and the identifier of a destination end system, and the management server determines a slot ID and a communication route (hereinafter referred to also as a “path” or a “flow”). Further, the end system 1 receives from a management server and holds the assigned slot ID and communication route information, and transmits a control packet including these data to the relay node 3 on the assigned communication route. The end system 1 as the destination is notified of these data via the relay node 3, and thus information on reservation of the slot is shared. Such a management server and slot reservation processing are similar to those of conventional techniques.

Turning now to the operations, in an application of the end system 1a or 1b, in the case where a packet to be transmitted to the end system 1c is generated (FIG. 4: step (1)) or in the case where the end system 1a or 1b receives, from another terminal that is not illustrated, a packet to be transmitted to the end system 1c, the received packet is stored in a queue corresponding to the destination end system. Note that if the corresponding queue does not exists, for example, a queue is generated and then the packet is stored therein, and, for the path in question, a slot assignment request is transmitted to the management server as mentioned above.

Independently of storage of the packet in the queue, the end system 1 transmits the packet stored in the queue at the timing of a slot (step (2)). Here, the end system 1 of this embodiment uses both a slot that has been reserved and a slot that is not reserved. Note that, a control packet transmitted in each slot is provided with a mark area for setting whether the transmission in question uses a slot based on a reservation, which allows determination of whether a data packet transmitted in the same slot as the control packet is to be transmitted pursuant to the reservation. That is, a slot (a guarantee region in FIG. 4) secured by a slot reservation ensures transmission, and therefore a data packet is transmitted, for example, without a mark (hereinafter referred to also as “marking”) in this slot. On the other hand, in a slot (a non-guarantee region in FIG. 4) that is not secured by a slot reservation, a data packet is transmitted with a mark on the understanding that discarding of the data packet is acceptable when crowding occurs inside a network (i.e., at a relay node). Accordingly, an assigned band is at least ensured.

In the example of FIG. 4, the end system 1a transmits packets using both a slot that has been reserved and a slot that is not reserved. Note that an “empty slot” is a slot that has been reserved but does not have a data packet to be transmitted because no packet to be transmitted exists at the timing of the slot. On the other hand, the end system 1b transmits a packet using a reserved slot only.

When receiving a packet to be relayed, a relay node specifies an output interface (IF) using a slot ID of a control packet as the key. The relay node also identifies the presence or absence of a mark from the mark area of the control packet. If the mark is absent, the data packet to be transmitted in the same slot as the control packet is a packet to be transmitted pursuant to a reservation and therefore is output from the output IF without buffering (step (3)). If the mark is present, the packet is temporarily stored in a wait queue prepared for each output IF (step (4)). Independently of reception of the packet, a packet in a wait queue is transmitted in a vacant slot (step (5)). Note that the vacant slot as used herein refers to a slot that has been reserved for any path and in which a packet to be transmitted does not exist ((A) of FIG. 4), or a slot that has not been reserved for any path ((B) of FIG. 4). As mentioned, a packet to be transmitted pursuant to a reservation is transmitted by using an assigned slot without buffering to the end system 1 as the destination, and a packet to be transmitted without a reservation is transmitted by using a slot in which no packet to be transmitted exists, for each of a link between the end system 1 and the relay node 3 and a link between the relay nodes 3.

The network system according to an embodiment of this technique includes the end system 1 and the relay node 3 as illustrated in FIG. 3.

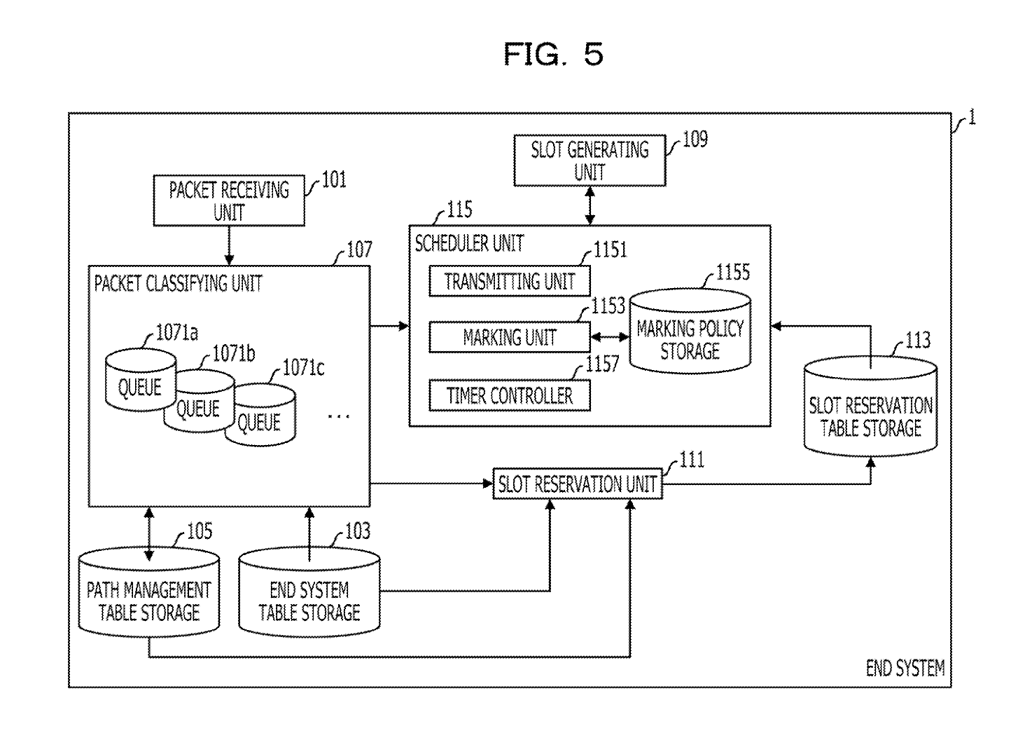

FIG. 5 is a block diagram illustrating functions of the end system 1 according to this embodiment. The end system 1 in this embodiment includes the packet receiving unit 101, an end system table storage 103, a path management table storage 105, a packet classifying unit 107, a slot generating unit 109, a slot reservation unit 111, a slot reservation table storage 113, and a scheduler unit 115. The scheduler unit 115 includes a transmitting unit 1151, a marking unit 1153, a marking policy storage 1155, and a timer controller 1157.

The packet receiving unit 101 receives a packet, for example, from an application executing unit (not illustrated) in the end system 1 or an external network and outputs it to the packet classifying unit 107. The packet classifying unit 107 generates or deletes queues 1071 (1071a, 1071b, 1071c, . . . in FIG. 5) corresponding to the destination end systems. On the basis of data stored in the end system table storage 103 and the path management table storage 105, the packet classifying unit 107 stores a packet received by the packet receiving unit 101 in any of the queues 1071, and in the case where a slot is not reserved, the packet classifying unit 107 notifies the slot reservation unit 111 of that effect. The slot generating unit 109 receives, from the management server, slot definition information including the number of slots included in one frame, a slot time, and a transmission time and outputs the information to the scheduler unit 115. The slot reservation unit 111 transmits a slot assignment request to the management server in response to an instruction from the packet classifying unit 107, and when receiving the assignment of a slot from the management server, the slot reservation unit 111 registers data associated with the assignment of the slot in the slot reservation table storage 113 using data stored in the end system table storage 103 and the path management table storage 105. On the basis of slot definition information received by the slot generating unit 109, synchronization time point information from the management server, and data stored in the slot reservation table storage 113, the transmitting unit 1151 of the scheduler unit 115 performs processing such as reading a data packet to be transmitted from the queue 1071 in the packet classifying unit 107 and transmitting it. Note that, in the case where a data packet to be transmitted by the transmitting unit 1151 is transmitted in a slot without a reservation on the basis of data stored in the marking policy storage 1155, the marking unit 1153 of the scheduler unit 115 sets data representing that effect in the mark area of a control packet. The timer controller 1157 controls interrupt processing performed by the scheduler unit 115.

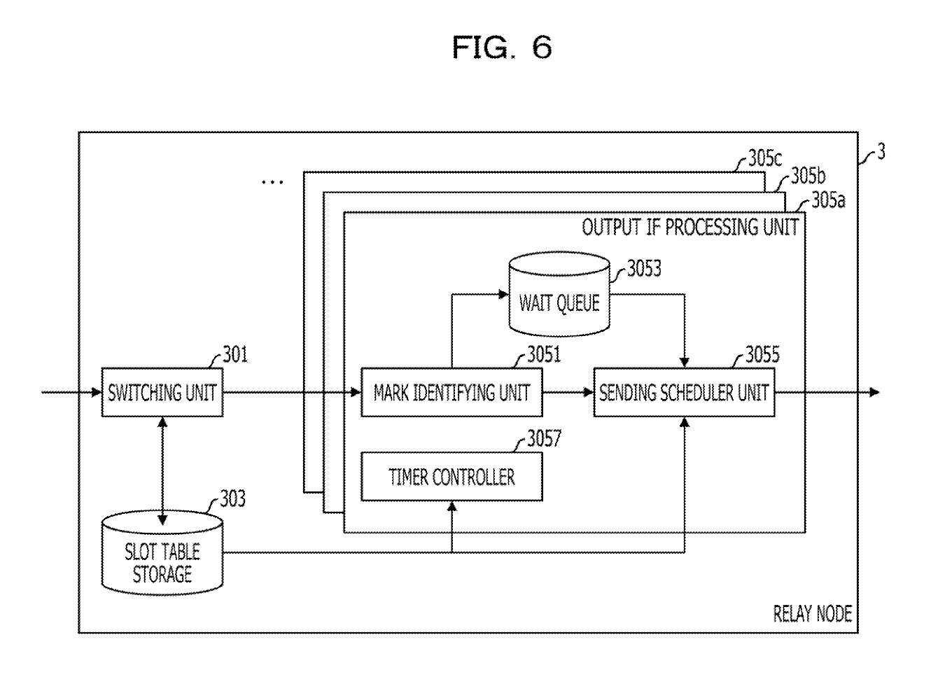

FIG. 6 is a block diagram illustrating functions of the relay node 3 according to the embodiment. The relay node 3 in this embodiment includes a switching unit 301, a slot table storage 303, and output interface (IF) processing units 305 (305a, 305b, 305c, . . . in FIG. 6).

The switching unit 301 receives a packet from the end system 1 or another relay node 3, and, on the basis of data stored in the slot table storage 303, outputs the packet to the output IF processing unit 305 corresponding to the output IF. A mark identifying unit 3051 of the output IF processing unit 305 identifies the mark area of a control packet, and stores in a wait queue 3053 the packet received in the same slot as the control packet if the mark is present, and outputs the packet to a sending scheduler unit 3055 if the mark is absent. The sending scheduler unit 3055 transmits the packet received from the mark identifying unit 3051 to the end system 1 or another relay node 3, or transmits the packet stored in the wait queue 3053 in a slot without any other packet to be transmitted. Note that the wait queue 3053 is prepared with a capacity capable of storing packets equivalent to one frame or several frames, for example. On the basis on data stored in the slot table storage 303, a timer controller 3057 controls interrupt processing performed by the output IF processing unit 305.

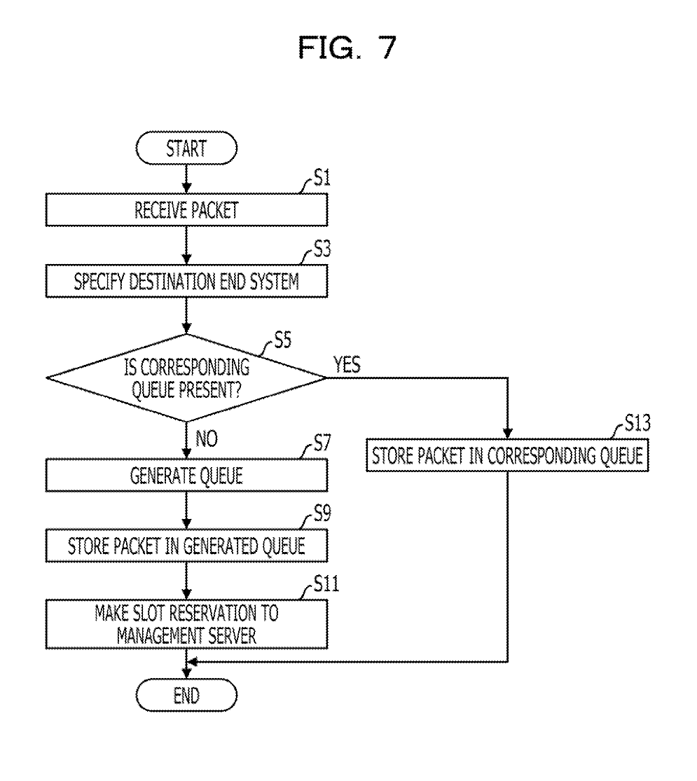

With reference to FIGS. 7 to 17, processing flows of the end system 1 and the relay node 3 will next be described.

Note that each end system 1 is assumed to have received in advance slot definition information including the number of slots, a slot time, and a transmission time and synchronization time point information from the management server, and synchronization of slots is assumed to be established in a network system. It is assumed that, a marking policy is set in the marking policy storage 1155, by the marking unit 1153, for each path that is defined by a combination of the source end system and the destination end system at the startup of the end system 1. The marking policy will be described in detail later. Further, route information is assumed to be registered in a slot table storage of the relay node 3.

FIG. 7 illustrates a processing flow in the case where a data packet to be transmitted in the end system 1 is generated or in the case where the end system 1 receives a packet to be relayed.

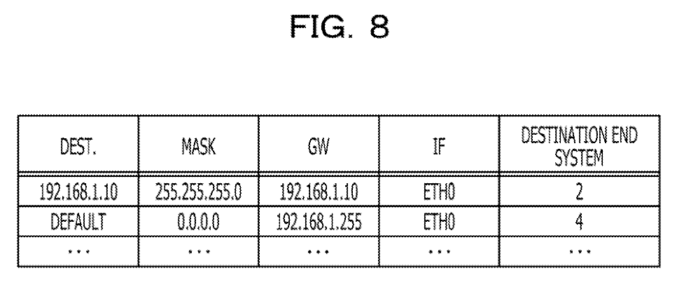

First, upon receipt of a packet from an application executing unit included in the end system 1 or an external apparatus, the packet receiving unit 101 outputs the packet to the packet classifying unit 107 (FIG. 7: step S1). For example, the packet receiving unit 101 receives a packet to be transmitted to the end system 1c, from an application executing unit (not illustrated) that executes an application program in the end system 1a. On the basis of an end system table stored in the end system table storage 103, the packet classifying unit 107 specifies a destination end system corresponding to the destination address of the packet (step S3). In the end system table storage 103, an end system table as illustrated in FIG. 8, for example, is stored. The end system table of FIG. 8 includes a column of destination addresses (Dest.), a column of net masks (Mask), a column of default gateways (GW), a column of output interfaces (IF), and a column of destination end systems. In this step, the destination end system is specified with the destination address of the packet serving as the key.

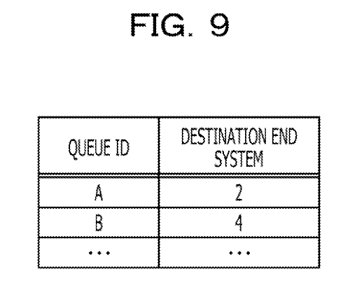

Then, on the basis of a path management table stored in the path management table storage 105, the packet classifying unit 107 determines whether the queue 1071 corresponding to the destination end system is present (step S5). In the path management table storage 105, a path management table as illustrated in FIG. 9, for example, is stored. The path management table of FIG. 9 includes a column of queue IDs and a column of destination end systems. In this step, it is determined whether the queue 1071 corresponding to the destination end system is registered.

If it is determined that the corresponding queue 1071 is not present, then the packet classifying unit 107 generates the queue 1071 and adds a record including the queue ID and the identifier of the specified destination end system to the path management table (step S7). Then, the packet classifying unit 107 stores the packet in the generated queue 1071 (step S9).

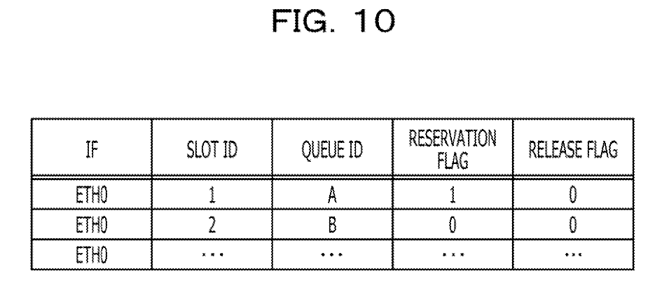

Further, the slot reservation unit 111 makes a slot reservation to the management server (step S11). In this step, the slot reservation unit 111 transmits a slot assignment request to the management server. The assigned slot ID and communication route information are received from the management server, and data is registered in a slot reservation table of the slot reservation table storage 113. Here, a slot reservation table as illustrated in FIG. 10 is stored in the slot reservation table storage 113. The slot reservation table of FIG. 10 includes a column of output interfaces (“IF”), a column of “slot ID”, a column of “queue ID”, a column of “reservation flag” (0: not reserved/1: reserved), and a column of “release flag” (0: not released/1: released). On the basis of communication route information received from the management server, the slot reservation unit 111 specifies an interface from the end system table and specifies the queue ID from the path management table. The slot reservation unit 111 adds a record including the identifier of the interface, the slot ID, and the queue ID to the slot reservation table. Then, processing at the time of receiving a packet is completed.

On the other hand, if it is determined in step S5 that the corresponding queue 1071 is present, then the packet classifying unit 107 stores the packet in the corresponding queue 1071 (step S13). Then, processing at the time of receiving a packet is completed.

With processing as described above, a packet received by the packet receiving unit 101 is stored in the queue 1071 prepared for each destination address. The packet stored in the queue 1071 is transmitted at an appropriate timing by processing that is performed separately.

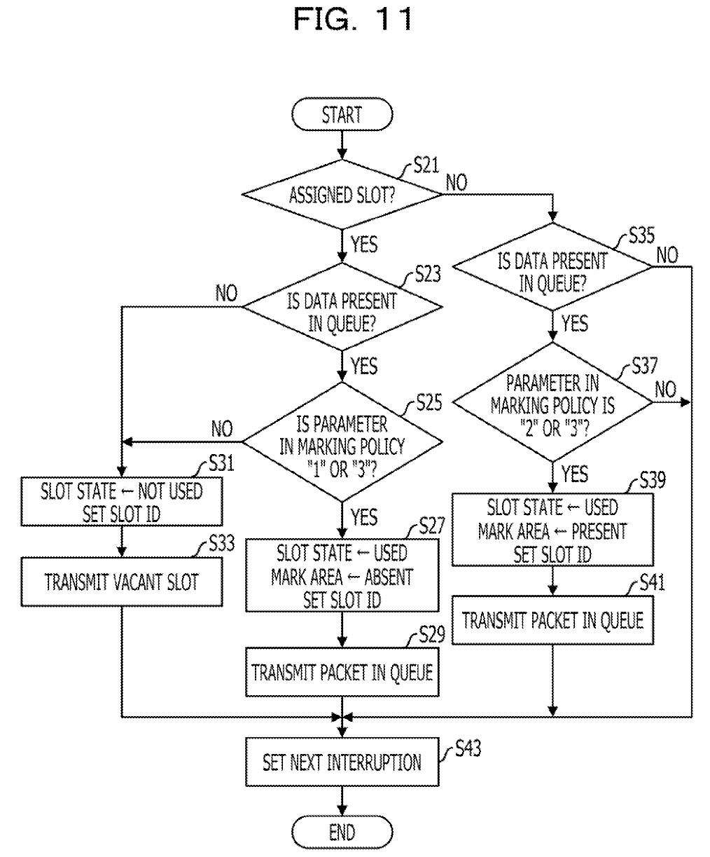

With reference to FIG. 11, a processing flow at the time of occurrence of timer interruption in the end system 1 will next be described. Here, independently of the foregoing processing at the time of receiving a packet, the timer controller 1157 of the scheduler unit 115 causes timer interrupt processing to occur at regular, slot-time intervals. This enables data transmission processing to be performed in accordance with slots. Note that, after startup, the end system 1 receives synchronization time point information and the like from the management server, and sets first interruption as initialization processing. Thereafter, occurrence of interruption and setting are repeated at slot-time intervals.

First, the transmitting unit 1151 of the scheduler unit 115 determines whether a slot to be processed is associated with any queue 1071 in a slot reservation table of the slot reservation table storage 113 (FIG. 11: step S21). If the slot is associated with any queue 1071, then the transmitting unit 1151 determines whether a packet is stored in the corresponding queue 1071 (step S23). Further, if the packet is stored in the queue 1071, then the marking unit 1153 of the scheduler unit 115 determines whether the parameter set for the source end system of a packet stored in the queue 1071 is “1” or “3” in the marking policy stored in the marking policy storage 1155 (step S25). In this step, if it is determined that the parameter is “1” or “3”, then, using a slot without marking (e.g., using a reserved slot to be processed), a packet of the queue 1071 associated with the slot is transmitted.

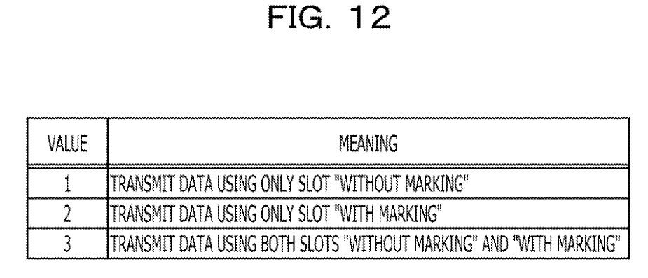

The marking policy in this embodiment is set, for example, as a parameter (referred to also as a “mark parameter”) for each path defined by a combination of the source end system and the destination end system. On the basis of the marking policy, the source end system determines which of a slot “without marking” and a slot “with marking” is used for packet transmission to a specific destination end system. FIG. 12 illustrates an example of values of mark parameters and the meanings of values. In this embodiment, the value of 1 indicates that data is transmitted using only a slot “without marking”, the value of 2 indicates that data is transmitted using only a slot “with marking”, and the value of 3 indicates that data is transmitted using both a slot “without marking” and a slot “with marking”. The value of a mark parameter is set for each path, and therefore, for example, the end system 1 can determine for each source end system whether packet transmission is to be performed using only a slot that has been reserved, using only a slot that is not reserved, or using both slots.

Further, the relationship between the marking policy and the traffic (e.g., transmitted data packets) will be described. For isochronous traffic (e.g., circuit switching traffic, performing delay guarantee transmission) such as voice and video, transmission is performed using only a slot “without marking”, ensuring a certain delay and band. For burst traffic (e.g., packet switching traffic, performing best-effort transmission) such as web data, transmission is performed using only a slot “with marking”, fully achieving the statistical multiplexing effect. Note that, in this case, for example, for a slot to be used, its guarantee region based on a reservation is set to zero (0) in the marking policy, and information on a path is registered in the relay node 3 when a packet is generated in the end system 1. For such traffic, a class of paths shared across the entirety may be prepared separately and controlled separately from paths assigned in this embodiment. In addition, for intermediate traffic (e.g., a combination of minimum guarantee of an assigned band and best-effort transmission), transmission is performed using both a slot “without marking” and a slot “with marking”, and thus the minimum band is ensured and the statistical multiplexing effect of traffic (with marking) in a band exceeding that band is achieved. Different kinds of traffic as described above are dispatched according to actual traffic conditions. Note that while the marking policy is set for each path in this embodiment, the marking policy may be set on the basis of other information representing the contents of traffic as described here.

A schematic representation of marking policies that the scheduler unit 115 has is as illustrated in FIG. 13, for example. In FIG. 13, mark parameters are set in such a manner that they are associated with identifiers of the source end systems.

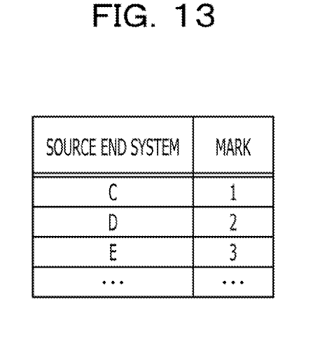

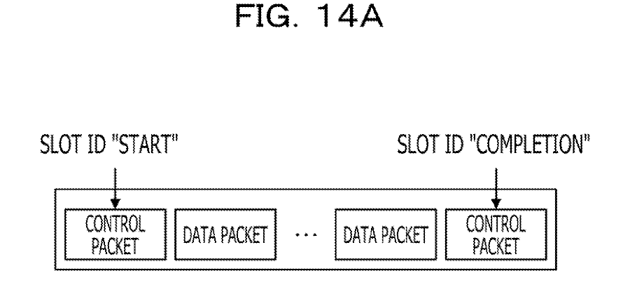

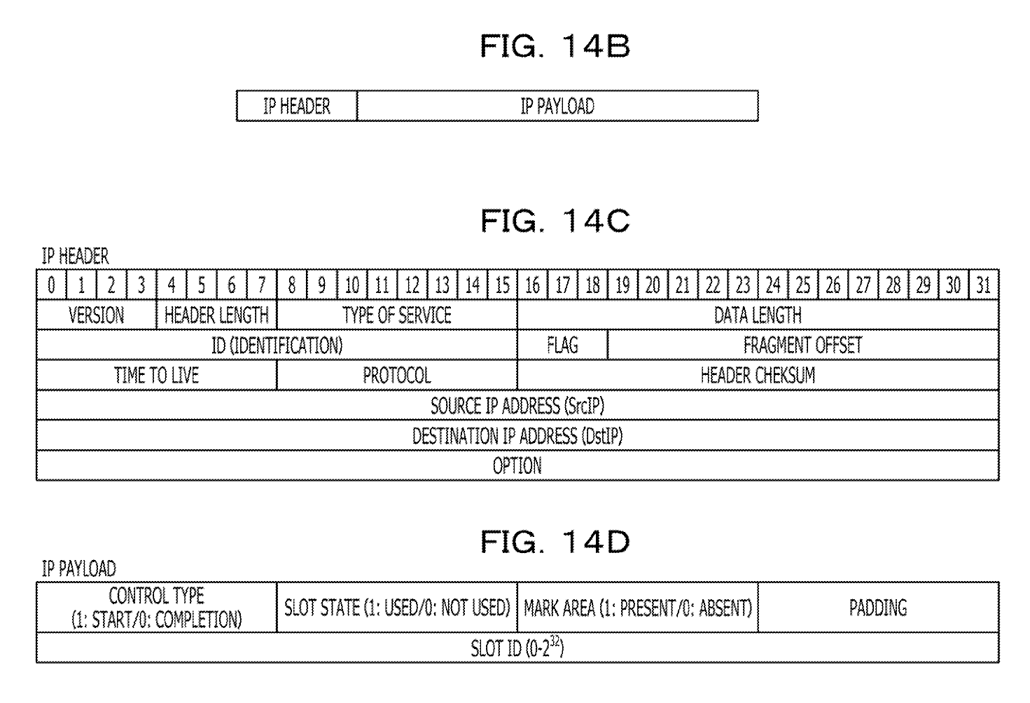

In this embodiment, as illustrated in FIG. 14A, control packets representing the start and the completion of a slot are transmitted and received at the beginning and the ending of each slot. Note that there may be an empty slot in which no data packet is present. FIGS. 14B to 14D illustrate an example of the format of a control packet in this embodiment. The control packet of this embodiment includes a typical IP header, and fields “control type (1: start/0: completion)”, “slot state (1: used/0: not used)”, “mark area (1: present/0: absent)” and “slot ID” are provided in the payload.

Note that the field “control type” is a value representing that this control packet is the start or the completion of a slot. As in FIG. 14C, this is information expressed by 8 bits, for example, and the value “1” represents the start and the value “0” represents the completion. The field “slot state” is a value representing whether this slot includes valid data or not. This is information expressed by 8 bits, for example, and the value “1” represents “used” (e.g., including a valid data packet) and the value “0” represents “not used” (e.g., not including a valid data packet). The field “mark area” is a value representing whether marking is marked on this control packet. This is information expressed by 8 bits, for example, and the value “1” represents the presence of marking, and the value “0” represents the absence of marking. The field “Padding” is provided for making uniform (32 bits) the boundary between this field and the field “slot ID”, and is a field of 8 bits and has no meaning. For example, all the values are 0. The field “slot ID” is a field representing the value of the slot ID. This is information expressed by 32 bits, for example, and the value ranges from 0 to 2³².

Turning now to the processing, the marking unit 1153 generates a control packet in which “used” is set in the slot state field, “absent” in the mark area field, and the slot ID of a slot to be processed in the slot ID field (step S27). The transmitting unit 1151 transmits the control packet and a data packet stored in the queue 1071 (step S29). Then, the process moves to step S43.

On the other hand, if it is determined in step S23 that a packet is absent in the queue 1071, or if it is determined in step S25 that the parameter of the marking policy is “2”, there is no packet to be transmitted in a slot to be processed. Accordingly, the marking unit 1153 generates a control packet in which “not used” is set in the slot state field, and the slot ID of a slot to be processed is set in the slot ID field (step S31). Then, the transmitting unit 1151 transmits only the control packet in the slot to be processed (step S33). An apparatus on the receiving side can determine from data set in the control packet that the slot is a vacant slot. Then, the process moves to step S43.

If it is determined in step S21 that the slot to be processed is not associated with any queue 1071, then the transmitting unit 1151 determines whether a packet is stored in any queue 1071 (step S35). That is, in the case of a slot without a reservation, it is determined whether there is a packet waiting for transmission to any destination end system. If the packet is not present in any queue 1071, then the process moves to step S43. On the other hand, if the packet is present in any queue 1071, then one queue 1071 is handled as that to be processed, and the marking unit 1153 determines whether the parameter set for the destination end system of that packet is “2” or “3” in the marking policy stored in the marking policy storage 1155 (step S37). If it is determined in this step that the parameter is “1”, then the process moves to step S43. On the other hand, if it is determined in step S37 that the parameter is “2” or “3”, then a packet in the queue 1071 to be processed can be transmitted using a slot with marking (e.g., using a slot to be processed that is not reserved). Therefore, the marking unit 1153 generates a control packet in which “used” is set in the slot state field and “present” is set in the mark area field (step S39). Then, the transmitting unit 1151 transmits the control packet and a data packet stored in the queue 1071 (step S41).

If it is determined in step S35 that the packet is not present in any queue 1071 or if it is determined in step S37 that the parameter is “1”, or after step S29, step S33, or step S41, the timer controller 1157 of the scheduler unit 115 performs setting of the next timer interruption so as to cause the next timer interruption to occur in one slot time after this timer interruption (step S43), and thus the processing at the time of occurrence of timer interruption is completed.

With processing as described above, a packet stored in the queue 1071 is transmitted. In this embodiment, according to the marking policy, a packet to be transmitted in a reserved slot is transmitted without a mark using a slot secured by a reservation. In other words, the set band is ensured. On the other hand, a packet that is allowed to be transmitted without a reservation, a slot that is not assigned by a reservation may be used. This results in the statistical multiplexing effect and improvement in network utilization efficiency.

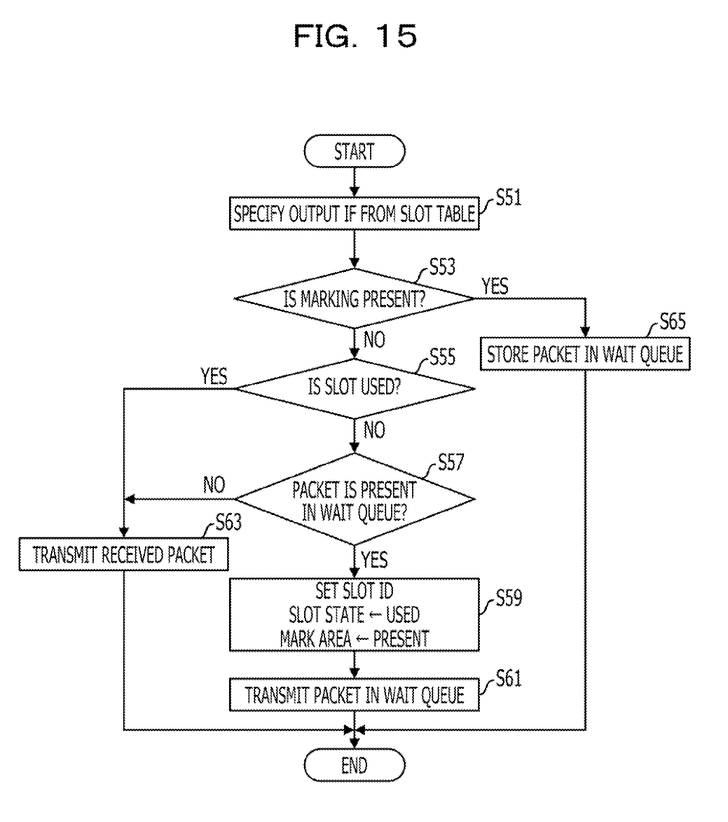

With reference to FIG. 15, a processing flow at the time of receiving a packet in the relay node 3 will next be described. This process starts with reception of a packet from the end system 1 or another relay node 3. Here, a description will be given assuming that the switching unit 301 of the relay node 3 has already received a packet.

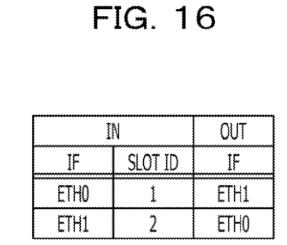

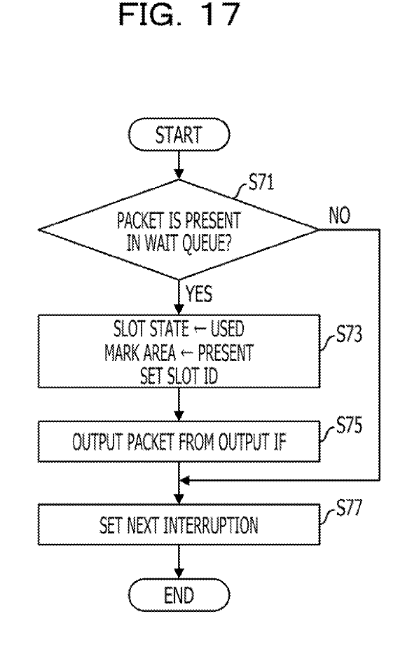

First, the switching unit 301 specifies an output IF from a slot table stored in the slot table storage 303 on the basis of the slot ID of a control packet, and outputs the received packet to the output IF processing unit 305 corresponding to the output IF (FIG. 15: step S51). Here, a slot table as illustrated in FIG. 16 is stored in the slot table storage 303. The slot table of FIG. 16 includes a column of inputs (IN) and a column of output interfaces (OUT (IF)). The column of inputs is divided into a sub-column of input interfaces (IF) and a sub-column of slot IDs. The identifiers of input interfaces and the identifiers of output interfaces used in packet communication in a time slot related to the record in question are set in the sub-column of input interfaces and the sub-column of output interfaces, respectively. Note that data related to a communication route is registered in advance in a slot table by a reservation of the time slot. Note also that the output IF is not uniquely determined with the position on the time axis of a slot in a frame, but is determined by using the slot ID as the clue. For example, the first and second slots (that do not mean slot IDs of 1 and 2) in the order within a frame may have the same slot ID and be output from the same output IF.

Then, the mark identifying unit 3051 of the output IF processing unit 305 identifies the mark area of the control packet and determines whether marking is present (step S53). If it is determined that marking is present, a packet received in the same slot as the control packet is transmitted without a reservation of the slot and therefore is not relayed in the same slot as the packet has been received. The mark identifying unit 3051 stores in the wait queue 3053 the packets that have been received in that slot (step S65). Here, if there is no free space in the wait queue 3053, the packet received in that slot is discarded. In this step, for example, a control packet is stored in the wait queue 3053 so as to be used in the later processing. Note that, without storing a control packet, the slot ID or the output IF may be made identifiable, which allows a new control packet to be generated in a later step. Then, the processing at the time of receiving a packet is completed.

On the other hand, if it is determined in step S53 that marking is absent, then the mark identifying unit 3051 identifies the slot state of the control packet and determines whether the slot in question is used (step S55). If it is determined that that slot is not used, then the sending scheduler unit 3055 determines whether a packet is stored in the wait queue 3053 (step S57). If a packet is stored in the wait queue 3053, then the sending scheduler unit 3055 replaces the slot ID of the received control packet with the slot ID of the packet stored in the wait queue 3053 and changes the slot state to “used” and the mark area to “present”. The control packet with the changed fields and the data packet stored in the wait queue 3053 are transmitted in that slot (step S61). Thus, the processing at the time of receiving a packet is completed.

If it is determined in step S55 that the slot in question is used, or if it is determined in step S57 that a packet is not present in the wait queue 3053, then the sending scheduler unit 3055 transmits these packets without buffering (step S63). Note that if it is determined in step S57 that a packet is not present in the wait queue 3053, only the control packet is transmitted, and an apparatus on the receiving side can determine from the slot state of the control packet that the slot is a vacant slot without a data packet.

With processing as described above, in the case where a packet to be relayed in a reserved slot is received, the packet is transmitted in the same slot (e.g., the reserved slot). Accordingly, as with the original time division multiplexing communication, the band assigned by a reservation is ensured. In the case where there is no packet to be relayed in a reserved slot, a packet stored in the wait queue 3053 is transmitted in that slot. That is, a packet that is allowed to be transmitted without a reservation is transmitted using a vacant slot. This results in the statistical multiplexing effect and improvement in network utilization efficiency.

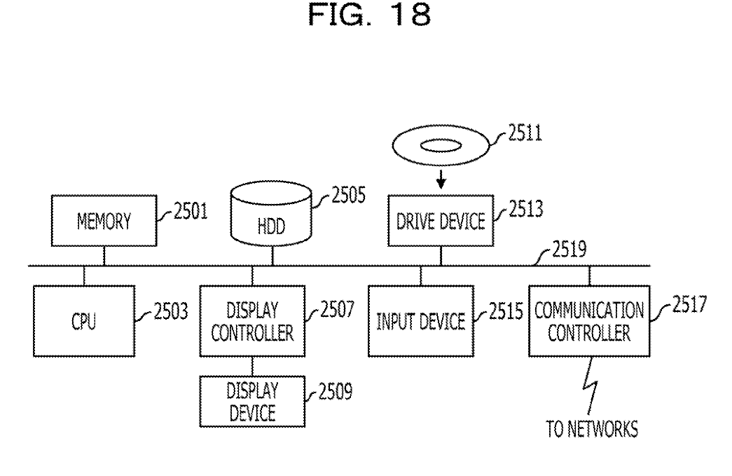

With reference to FIG. 17, a processing flow at the time of occurrence of timer interruption in the relay node 3 will next be described. Here, independently of the foregoing processing at the time of receiving a packet, timer interrupt processing is caused to occur in accordance with the start time of a slot without a reservation for the output IF. This enables processing of transmitting data in a wait queue to be performed in accordance with a vacant slot. Note that the first interruption is set by initialization processing, and thereafter the timer controller 3057 specifies the next vacant slot on the basis of the slot table and sets an interruption in accordance with the vacant slot.

Upon occurrence of a timer interruption, the sending scheduler unit 3055 of the output IF processing unit 305 determines whether a packet is stored in the wait queue 3053 (FIG. 17: step S71). If a packet is stored, then the sending scheduler unit 3055 sets, for example, for a stored control packet, “used” in the slot state field, “present” in the mark area field, and the slot ID corresponding to the output IF of that packet in the slot ID field (step S73). Then, the sending scheduler unit 3055 transmits, in that slot, the control packet and the data packet stored in the wait queue 3053 (step S75).

After step S75 or if no packet is stored in the wait queue 3053 in step S71, the timer controller 3057 sets the next interruption such that a timer interruption occurs in the next empty slot (step S77). To find out the time of the next vacant slot, the reservation statuses of slots for a specific output IF registered in a slot table are arranged on the time axis, and the time at which the next vacant slot appears is specified. Note that, for example, the reservation status of a slot and the next start time of the slot may be held in such a manner that they are associated with each other, allowing the time of a vacant slot to be extracted. The slot time may be held in advance such that, on the basis of this, the time of a vacant slot can be calculated. Then, processing at the time of occurrence of a timer interruption is completed.

With processing as described above, a packet that is allowed to be transmitted without a reservation and that has been held is transmitted using a slot without an assignment conditioned by a reservation. This results in the statistical multiplexing effect and improvement in network utilization efficiency.

As the entire network system, when a slot that has been reserved is not used, or when a slot is not reserved, the slot is used for another path on a link-by-link basis, which makes it possible to achieve the statistical multiplexing effect and to improve the network utilization efficiency. In cases where communication with less losses is needed, transmission is performed without a mark using only a slot that has been reserved, and thus communication with less delays and less losses can be achieved. In conventional packet switching and multi-protocol label switching (MPLS), a buffer memory ranging from several hundred MB to several GB is used for a relay apparatus. In contrast, the relay node 3 according to this embodiment only requires a memory corresponding to one frame (about several hundred KB), and therefore it is possible to achieve cost reduction and power savings.

While the embodiment of this technique has been described above, this technique is not limited to this embodiment. For example, the block diagrams illustrating functions are exemplary, and their configurations sometimes do not match actual program module configurations. For the processing flows, the order of steps may be changed or may be carried out in parallel as long as the processing results are the same.

It is to be noted that the foregoing end system 1 may be a computer device. In a computer device, for example, as illustrated in FIG. 18, a memory 2501, a CPU 2503, a hard disk drive (HDD) 2505, a display controller 2507 connected to a display device 2509, a drive device 2513 for a removable disk 2511, an input device 2515, and a communication controller 2517 for connection to networks are connected via a bus 2519. An operating system (OS) and application programs for performing processing in this embodiment are stored in the HDD 2505 and read out from the HDD 2505 to the memory 2501 when executed by the CPU 2503. The CPU 2503 controls the display controller 2507, the communication controller 2517, and the drive device 2513 in accordance with the processing contents of the application programs to cause them to perform predetermined operations. Data in processing is stored mainly in the memory 2501, and may be stored in the HDD 2505. In the embodiment of this technique, application programs for performing the foregoing processing are stored in the computer-readable removal disk 2511 and distributed in such a form, and are installed in the HDD 2505 from the drive device 2513. They may be installed in the HDD 2505 through networks such as the Internet and the communication controller 2517. In such a computer device, hardware, such as the CPU 2503 and the memory 2501 mentioned above, and programs, such as the OS and application programs, organically cooperate with each other to realize various functions as described above.

Note that a program for causing a computer to perform processing in the above-mentioned way may be created. The program is stored in a computer-readable recording storage medium such as a flexible disk, CD-ROM, optical magnetic disk, semiconductor memory, or hard disk or a storage device. Intermediate processing results are temporarily stored in a storage device such as a main memory.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

What is claimed is:

1. A relay apparatus for performing packet communication of time division, the relay apparatus comprising:
a receiver configured to receive a first data packet to be transmitted according to a reservation of a time slot, a second data packet being a data packet other than the first data packet, and a control packet including first data representing which of the first data packet and the second data packet is to be transmitted in the same time slot as the control packet;
a processor configured to store in a data storage the second data packet, the second data packet being received by the receiver in a time slot in which the control packet is received, when the receiver receives a control packet including first data representing that the second data packet is to be transmitted in the same time slot as the control packet; and
a transmitter configured to transmit the second data packet stored in the data storage in a time slot not including other data packet than the second data packet.

2. The relay apparatus according to claim 1, wherein
the control packet further includes second data representing whether the first data packet or the second data packet is to be transmitted, and
the transmitter transmits the second data packet stored in the data storage and a second control packet including first data representing that the second data packet is to be transmitted in the same time slot as the second control packet when in a time slot in which a first control packet including second data representing that any of the first data packet and the second data packet is not transmitted has been received.

3. The relay apparatus according to claim 1 wherein, in a time slot without a reservation, the transmitter transmits the second data packet stored in the data storage and a third control packet including first data representing that the second data packet is to be transmitted in the same time slot as the third control packet.

4. The relay apparatus according to claim 2 wherein, in a time slot without a reservation, the transmitter transmits the second data packet stored in the data storage and a third control packet including first data representing that the second data packet is to be transmitted in the same time slot as the third control packet.

5. A communication apparatus for performing packet communication of time division, the communication apparatus comprising:
a data storage configured to store data representing a reservation status of a time slot; and
a processor configured to transmit in the time slot under consideration the data packet capable of being transmitted without a reservation of a time slot and a control packet including data representing that a data packet other than a data packet to be transmitted pursuant to a reservation of a time slot is to be transmitted in the same time slot as the control packet, when a data packet capable of being transmitted without a reservation of a time slot is present and it is determined on the basis of data stored in the data storage that a time slot under consideration is not reserved.

6. A network system comprising:
a communication apparatus configured to perform packet communication of time division; and
a relay apparatus,
the communication apparatus including:
a data storage configured to store data representing a reservation status of a time slot; and
a processor configured to transmit in the time slot under consideration the data packet capable of being transmitted without a reservation of a time slot and a control packet including data representing that a second data packet is to be transmitted in the same time slot as the control packet, the second data packets being a data packet other than a first data packet to be transmitted pursuant to a reservation of a time slot, when a data packet capable of being transmitted without a reservation of a time slot is present and it is determined on the basis of data stored in the data storage that a time slot under consideration is not reserved; and
the relay apparatus including:
a receiver configured to receive a control packet including data representing which of the first data packet and the second data packet is to be transmitted in the same time slot as the control packet, the first data packet, and the second data packet;
a processor configured to store in a data holding unit the second data packet received by the receiver in a time slot of reception of the control packet, when the receiver receives the control packet including data representing that the second data packet is to be transmitted in the same time slot as the control packet; and
a transmitter configured to transmit the second data packet stored in the data holding unit in a time slot without other data packet than the second data packet.
